(19) United States
(12) Patent Application Publication
(10) Pub. No.: US 2025/0098055 A1
(43) Pub. Date: Mar. 20, 2025

(54) LIGHT EMITTING DEVICE AND SYSTEM INCLUDING THE SAME

(71) Applicant: SEOUL SEMICONDUCTOR CO., LTD., Ansan-si (KR)

(72) Inventors: KeonYong LEE, Ansan-si (KR); KwangBea LIM, Ansan-si (KR); Chunghoon LEE, Ansan-si (KR)

(73) Assignee: SEOUL SEMICONDUCTOR CO., LTD., Ansan-si (KR)

(21) Appl. No.: 18/825,917

(22) Filed: Sep. 5, 2024

Related U.S. Application Data
(60) Provisional application No. 63/536,810, filed on Sep. 6, 2023.
(60) Provisional application No. 63/674,870, filed on Jan. 1, 0001.

(51) Int. Cl. H05B 47/19; H05B 47/11; H05B 47/16

(52) U.S. Cl. CPC H05B 47/19; H05B 47/11; H05B 47/16

(57) ABSTRACT

A light emitting device includes: a light emitter for generating light; a communication unit that communicates externally through a first communication mode to receive time information and communicates externally through a second communication mode different from the first communication mode; and a controller for controlling a correlated color temperature of the light of the light emitter based on the time information. Further, the communication unit transmits the time information received using the first communication mode externally through the second communication mode.

### TECHNICAL FIELD

The present disclosure relates to a light emitting device and a light emitting system including the same.

### BACKGROUND

In general, lighting devices installed indoors are manufactured in various forms and shapes, and their typical configuration includes a main body, to be fixed to a ceiling or wall, etc., which has a light source that emits light and various parts related thereto, and a light-transmitting cover which is manufactured to maintain illumination and to form an attractive appearance.

Meanwhile, the lighting devices may be controlled to different brightness and color temperatures through individual or group control to create space. However, conventional lighting devices have a problem in that they cannot generate light with a color temperature similar to that of natural light over time.

### SUMMARY

In view of the above, one embodiment of the present disclosure provides a light emitting device that generates light with a color temperature similar to that of natural light and a light emitting system including the same.

Further, one embodiment of the present disclosure provides a light emitting device with improved security and a light emitting system including the same.

Further, one embodiment of the present disclosure provides a light emitting device with reduced power consumption and a light emitting system including the same.

Further, one embodiment of the present disclosure provides a light emitting system that can control other light emitting devices through one of a plurality of light emitting devices.

Further, one embodiment of the present disclosure provides a light emitting system in which all of the plurality of light emitting devices can emit light even if at least one of the plurality of light emitting devices is far away.

In accordance with a first embodiment of the present application, there is provided a light emitting device including: a light emitter for generating light; a communication unit that communicates externally through a first communication mode to receive time information and communicates externally through a second communication mode different from the first communication mode; and a controller for controlling a correlated color temperature of the light of the light emitter based on the time information.

Further, the communication unit may transmit the time information received using the first communication mode externally through the second communication mode.

Further, the communication unit may communicate with another light emitting device using the second communication mode and transmit the time information received using the first communication mode to the another light emitting device.

Further, the first communication mode may be a Wi-Fi mode.

Further, the second communication mode may be a Bluetooth mode.

Further, the light emitter may be configured to generate light having a correlated color temperature of 2700K to 6500K.

Further, time-correlated color temperature correlation information, which is color temperature data for time data, may be input in advance in the controller, and the controller may control the correlated color temperature of the light generated by the light emitter based on the time-correlated color temperature correlation information.

Further, the controller may select time data corresponding to the time information from the time-correlated color temperature correlation information, select color temperature data corresponding to the selected time data, and control the light emitter based on the selected color temperature data.

Further, the time data may include a plurality of time data values, the color temperature data may include a plurality of correlated color temperature data values, and the time-correlated color temperature correlation information may include a correspondence relationship between the plurality of time data values and the plurality of correlated color temperature data values.

In accordance with a second embodiment of the present application, there is provided a light emitting device including: a light emitter for generating light; a communication unit that communicates externally through a first communication mode and communicates externally through a second communication mode different from the first communication mode to receive a driving signal; and a controller that drives the light emitter to emit light when the driving signal is received.

Further, the communication unit may transmit the driving signal received using the second communication mode externally through the second communication mode.

Further, the communication unit may communicate with another light emitting device using the second communication mode to transmit the driving signal to the another light emitting device.

In accordance with a third embodiment of the present application, there is provided a light emitting system including: a light emitting device that generates light; and a transmission terminal that communicates with the light emitting device to transmit time information to the light emitting device, wherein the light emitting device includes: a light emitter for generating light; and a communication unit that communicates with the transmission terminal using a first communication mode to receive the time information and communicates externally through a second communication mode different from the first communication mode; and a controller for controlling a correlated color temperature of the light of the light emitter based on the time information.

Further, the light emitting device may be provided in plurality, and the communication units of the plurality of light emitting devices may communicate with each other using the second communication mode.

Further, the light emitting device may be provided in plurality, and the plurality of light emitting devices may include: one master light emitting device that receives the time information transmitted from the transmission terminal; and a plurality of slave light emitting devices that receive the time information transmitted from the master light emitting device.

Further, the communication unit of the master light emitting device may transmit a driving signal received from an external using the second communication mode to the plurality of slave light emitting devices using the second communication mode.

Further, the plurality of light emitting devices may further include a first sub-light emitting device that receives the time information transmitted from the master light emitting device and transmits the time information to some of the plurality of slave light emitting devices. Further, the plurality of slave light emitting devices may be grouped into a plurality of groups, the plurality of groups may include: a first group including some of the plurality of slave light emitting devices; and a second group including another some of the plurality of slave light emitting devices, the plurality of slave light emitting devices included in the first group may receive the time information from the master light emitting device, and the plurality of slave light emitting devices included in the second group may receive the time information from the first sub-light emitting device.

Further, among the slave light emitting devices included in the first group, the slave light emitting device with a largest separation distance from the master light emitting device may be set as the first sub light emitting device.

Further, the plurality of light emitting devices may further include a second sub-light emitting device that receives the time information transmitted from the first sub-light emitting device, the plurality of groups may further include a third group including still another some of the plurality of slave light emitting devices, and the plurality of slave light emitting devices included in the third group may receive the time information transmitted from the second sub-light emitting device.

According to one embodiment of the present disclosure, the light emitting device of the light emitting system can generate light with a color temperature similar to natural light according to the current time.

In addition, according to one embodiment of the present disclosure, security can be improved because the light emitting device of the light emitting system can receive the driving signal in the second communication method.

Further, according to one embodiment of the present disclosure, power consumption can be reduced because a plurality of light emitting devices of the light emitting system can communicate with each other in the second communication method.

Furthermore, according to one embodiment of the present disclosure, through any one of the plurality of light emitting devices of the light emitting system, another light emitting device can be controlled.

In addition, according to one embodiment of the present disclosure, even when the plurality of light emitting devices of the light emitting system are far apart from each other, at least some of them can be connected by the sub-light emitting device, so that all of the plurality of light emitting devices can emit light.

### BRIEF DESCRIPTION OF THE DRAWINGS

FIG. 1 is a diagram illustrating a communication method of a light emitting device, a transmission terminal, and a control terminal of a light emitting system according to a first embodiment of the present disclosure.

FIG. 2 is an exploded perspective view of the light emitting device of the light emitting system of FIG. 1.

FIG. 3 is a plan view of a light emitting part of the light emitting device of FIG. 2.

FIG. 4 is a diagram illustrating a light emitting system according to a second embodiment of the present disclosure.

FIG. 5 is a diagram illustrating a control terminal of the light emitting system of FIG. 4.

FIG. 6 is a diagram illustrating a light emitting system according to a third embodiment of the present disclosure.

### DETAILED DESCRIPTION

In the following description, for the purposes of explanation, numerous specific details are set forth in order to provide thorough understanding of various exemplary embodiments or implementations of the present disclosure. As used herein, “embodiments” and “implementations” are interchangeable terms for non-limiting examples of devices or methods employing one or more of the inventive concepts disclosed herein. It will be apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects (hereinafter individually or collectively referred to as “elements”) of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, and property of the elements, unless specified. Further, in the accompanying drawings, the size and relative sizes of elements may be exaggerated for clarity and/or descriptive purposes. When an exemplary embodiment is implemented differently, a specific process order may be performed differently from the described order. For example, two consecutively described processes may be performed substantially at the same time or performed in an order opposite the described order. In addition, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the DR1-axis, the DR2-axis, and the DR3-axis are not limited to three axes of a rectangular coordinate system, such as the x, y, and z-axes, and may be interpreted in a broader sense. For example, the DR1-axis, the DR2-axis, and the DR3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” and the like may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (for example, as in “sidewall”), and the like, may be used herein for descriptive purposes, and, thereby, to describe one element's relationship to other element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (for example, rotated 90 degrees or at other orientations), and, as such, the spatially relative descriptors used herein may likewise interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (for example, microcode) to perform various functions discussed herein and may optionally be driven by firmware and/or software. It is also contemplated that each block, unit, and/or module may be implemented by dedicated hardware, or as a combination of dedicated hardware to perform some functions and a processor (for example, one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure pertains. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, a light emitting device 100 and a light emitting system 1 including the same, according to one embodiment of the present disclosure, will be described with reference to the drawings.

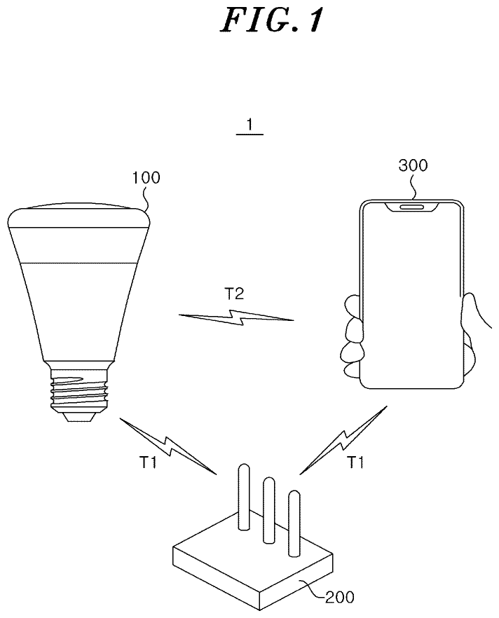

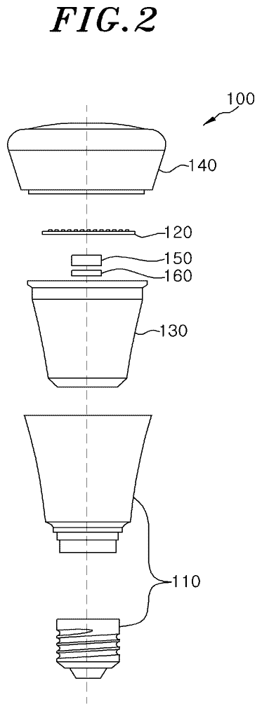

Referring to FIGS. 1 and 2, the light emitting device 100 and the light emitting system 1 including the same, according to one embodiment of the present disclosure, can form a correlated color temperature of light from the light emitting device 100 to be similar to the correlated color temperature of natural light. The natural light is light emitted from the sun toward a space where the light emitting device 100 is installed, and may change according to the current time. In other words, the light emitting system 1 can change the correlated color temperature of light from the light emitting device 100 according to the current time. The light emitting system 1 may include one or more of a light emitting device 100, a transmission terminal 200, and a control terminal 300.

The light emitting device 100 can generate light. The light emitting device 100 may be installed indoors, but is not limited thereto. The correlated color temperature of the light generated by the light emitting device 100 can be formed to be similar to the correlated color temperature of natural light. The light emitting device 100 may include a housing 110, a light emitter 120, a heat sink 130, a cover 140, a communication unit 150, and a controller 160.

The housing 110 may accommodate the light emitter 120, the heat sink 130, the communication unit 150, and the controller 160. An aperture may be formed in one side of the housing 110 so that the light emitter 120, the heat sink 130, the communication unit 150, and the controller 160 can be accommodated therein. The housing 110 may form the exterior of the light emitting device 100. For example, the housing 110 may be formed in various structures in the form of a light bulb such as a bulb, ball, or Edison, a socket type such as a krypton or candlestick type, or various lighting shapes such as an EL type, a PAR type, and a down light, as well as automobile headlamp, a real light, and a flash for a cell phone.

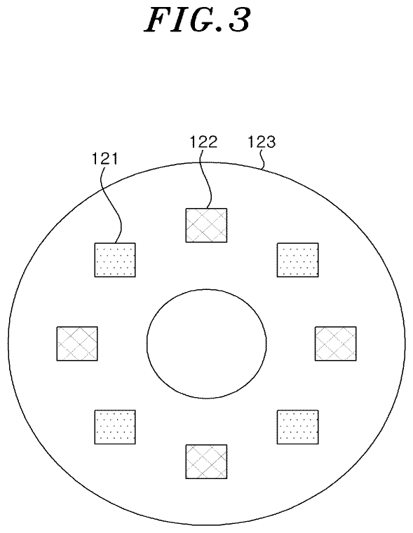

Referring further to FIG. 3, the light emitter 120 can generate light. For example, the light emitter 120 can generate light having a correlated color temperature of 2700 K to 6500 K. In addition, the light emitter 120 may have one or more light emitting elements capable of generating light and a wavelength conversion unit. The wavelength conversion unit may include a resin including a phosphor, QD, etc. For example, (Ba, Sr, Ca)₂SiO₄: Eu²⁺, YAG ((Y, Gd)₃(Al, Ga)₅O₁₂:Ce³⁺) series phosphor, TAG ((Tb, Gd)₃(Al, Ga)₅O₁₂:Ce³⁺) series phosphor, (Ba, Sr, Ca)₃SiO₅:Eu²⁺, (Ba, Sr, Ca)MgSi₂O₆:Eu²⁺, Mn²⁺, (Ba, Sr, Ca)₃MgSi₂O₈:Eu²⁺, Mn²⁺ and (Ba, Sr, Ca)MgSiO₄:Eu²⁺, Mn²⁺, or a fluoride-based phosphor represented by A₂MF₆:Mn⁴⁺, where A may be Li, Na, K, Ba, Rb, Cs, Mg, Ca, Se or Zn, and M may be at least one species selected from the group consisting of Ti, Si, Zr, Sn, or Ge.

In addition, the light emitter 120 may include two or more sub-light emitters 121 and 122 having different correlated color temperatures (CCT) as light emitting elements, and a substrate 123. The light emitter 120 may generate light between the correlated color temperatures of the sub-light emitters 121 and 122 by combining the sub-light emitters 121 and 122. For example, the light emitter 120, which includes a first sub-light emitter 121 that emits light with a correlated color temperature of 1700K or more and a second sub-light emitter 122 that emits light with a correlated color temperature of 7000K or less, may emit light with a correlated color temperature between 1700K and 7000K.

In other words, the correlated color temperature of the light emitter 120 including the different first and second sub-light emitters 121 and 122 may be the same as or higher than that of the first sub-light emitter 121, and may be the same as or less than that of the second sub-light emitter 122.

In addition, the first sub-light emitter 121 and the second sub-light emitter 122 may be arranged alternately along the edge of the substrate 123 or may be arranged separately in different regions of the substrate 123.

The substrate 123 may support a plurality of first sub-light emitters 121 and a plurality of second sub-light emitters 122. The substrate 123 may be made by adding a wiring section formed of a metal such as Cu, Al, Ag, Au, Ni, W, or the like, and a metal compound on a substrate of alumina, quartz, calcium zirconate, forsterite, SiC, graphite, fused silica, mullite, cordierite, zirconia, beryllia, and aluminum nitride, LTCC (low temperature co-fired ceramic), paper phenolic, or epoxy resin combined with glass or paper, or an insulating layer formed of P.I (Polyimide), B.T (Bismaleimide/Triazine), Teflon (Teflon), or the like.

The heat sink 130 may be provided inside the housing 110 to dissipate heat from inside the housing 100. The heat sink 130 may support the light emitter 120, the communication unit 150, and the controller 160. In other words, the heat sink 130 can dissipate heat of the light emitter 120, the communication unit 150, and the controller 160 to the outside. The heat sink 130 may be made of a material having high thermal conductivity, such as aluminum, copper, or iron, and may be made of a material having a thermal conductivity of 100 W/mK or higher. More preferably, the heat sink 130 may be formed to have a thermal conductivity of 200 W/mK or higher, but is not limited thereto.

The cover 140 may be detachably coupled to the housing 110 to cover the aperture of the housing 110. In addition, the cover 140 may be formed to transmit light generated from the light emitter 120, and preferably may be formed of a material having a transmittance of 80% or more. The cover 140 may be made of a glass material such as soda lime glass, borosilicate glass, or borosilicate, and may be made of PP, PC, PMMA, acrylic resin, or the like. Further, in order to increase color uniformity when the light from the light emitter 120 transmits through the cover 140, the cover 140 may be coated with an additive such as silica (SiO₂), titanium dioxide (TiO₂), alumina (Al₂O₃), or barium sulfate (BaSO₄) to disperse or diffuse the light. In addition, the cover 140 may be manufactured in a shape such as Fresnel shape or irregularities to increase color uniformity.

The communication unit 150 may communicate externally using at least one of a first communication method and a second communication method. The first communication method and the second communication method are different communication methods. The first communication method may be a Wi-Fi method, and the second communication method may be a Bluetooth method. In addition, the communication unit 150 may include a Bluetooth Low Energy (BLE) module for communication using the Bluetooth method. The communication unit 150 can communicate with the outside at low power using the Bluetooth module. In this case, the first communication method and the second communication method may have different communication bands. For example, the first communication method may have a communication band of 5 GHZ, and the second communication method may have a band of 2.5 GHZ, thereby minimizing interference between the first communication method and the second communication method. In addition, the first communication method and the second communication method may have the same communication band. For example, the first communication method and the second communication method may have a band of 2.5 GHz and can minimize power consumption by using the same low band.

The communication unit 150 may communicate with the transmission terminal 200 using the first communication method. In addition, the communication unit 150 may communicate with the control terminal 300 or another light emitting device using the second communication method. In other words, the communication unit 150 may communicate with the transmission terminal 200 using the first communication method to receive time information from the transmission terminal 200 and may transmit the time information to another external light emitting device using the second communication method. Further, the communication unit 150 may communicate with the control terminal 300 using the second communication method to receive at least one of a driving signal and an input data value from the control terminal 300 and may transmit at least one of the driving signal and the input data value to another external light emitting device using the second communication method.

In addition, the communication unit 150 may receive at least one of the driving signals and time information transmitted from another light emitting device using the second communication method, and transmit it to another light emitting device using the second communication method. Further, the communication unit 150 may transmit status information of the light emitter 120, such as whether the light emitter 120 is driven or not, and the correlated color temperature of the light generated by the light emitter 120, to the control terminal 300 using the second communication method.

The controller 160 may control the light emitter 120 based on the communication of the communication unit 150. The controller 160 may control the light emitter 120 to emit light based on the driving signal received by the communication unit 150.

The controller 160 may change the correlated color temperature of the light of the light emitter 120 based on the time information received by the communication unit 150. The time information may include a time value, a date value, location information, an amount of sunlight according to the location, etc. In addition, time-correlated color temperature correlation information, which is color temperature data for time data, may be input in advance into the controller 160. In other words, the controller 160 may control the correlated color temperature of the light generated by the light emitter 120 based on the time information transmitted from the transmission terminal 200 and the time-correlated color temperature correlation information. In this case, the communication unit 150 may obtain the time information in the initial setting stage and operate based on the information stored in the controller 160, so that it does not have to continuously communicate with the transmission terminal 200 during operation, thereby reducing power consumption.

For example, the time-correlated color temperature correlation information may be input to the controller 160 in a table format as shown in Table 1 below. The time data may include a plurality of time data values, the color temperature data may include a plurality of correlated color temperature data values, and the time-correlated color temperature correlation information may include a correspondence between the plurality of time data values and the plurality of correlated color temperature data values. In addition, in the time-correlated color temperature correlation information, the plurality of time data values and the plurality of correlated color temperature data values may be divided by seasonal section.

TABLE 1
Scenario (Gen.1)

| | Season | | | | | | | | | | | | |
|---|---|---|---|---|---|---|---|---|---|---|---|---|---|
| | Spring | | | Summer | | | Autumn | | | Winter | | | |
| Time | March | April | May | June | July | August | September | October | November | December | January | February | Duty |
| 0:00 | 2700K | 2700K | 2700K | 2700K | 2700K | 2700K | 2700K | 2700K | 2700K | 2700K | 2700K | 2700K | 70% |
| 1:00 | 2700K | 2700K | 2700K | 2700K | 2700K | 2700K | 2700K | 2700K | 2700K | 2700K | 2700K | 2700K | 70% |
| 2:00 | 2700K | 2700K | 2700K | 2700K | 2700K | 2700K | 2700K | 2700K | 2700K | 2700K | 2700K | 2700K | 70% |
| 3:00 | 2700K | 2700K | 2700K | 2700K | 2700K | 2700K | 2700K | 2700K | 2700K | 2700K | 2700K | 2700K | 70% |
| 4:00 | 2700K | 2700K | 2700K | 2700K | 2700K | 2700K | 2700K | 2700K | 2700K | 2700K | 2700K | 2700K | 70% |
| 4:30 | 2700K | 2700K | 2700K | 2900K | 3100K | 2900K | 2700K | 2700K | 2700K | 2700K | 2700K | 2700K | |
| 5:00 | 2700K | 2700K | 2900K | 3200K | 3500K | 3200K | 2900K | 2700K | 2700K | 2700K | 2700K | 2700K | 70% |
| 5:30 | 2900K | 3100K | 3300K | 3500K | 3800K | 3500K | 3300K | 3100K | 2900K | 2700K | 2700K | 2700K | |
| 6:00 | 3200K | 3500K | 3600K | 3700K | 3900K | 3700K | 3600K | 3500K | 3200K | 2900K | 2700K | 2900K | 80% |
| 6:30 | 3500K | 3800K | 3900K | 4000K | 4100K | 4000K | 3900K | 3800K | 3500K | 3300K | 3100K | 3300K | |
| 7:00 | 3800K | 4000K | 4100K | 3200K | 4400K | 4200K | 4100K | 4000K | 3800K | 3600K | 3500K | 3600K | 90% |
| 7:30 | 4100K | 4300K | 4400K | 4500K | 4600K | 4400K | 4200K | 4300K | 4100K | 3900K | 3800K | 3900K | |
| 8:00 | 4300K | 4500K | 4600K | 4700K | 4800K | 4700K | 4600K | 4500K | 4300K | 4200K | 4100K | 4200K | 100% |
| 8:30 | 4600K | 4800K | 4800K | 4900K | 5000K | 4900K | 4800K | 4800K | 4600K | 4500K | 4400K | 4500K | |
| 9:00 | 4900K | 5000K | 5000K | 5100K | 5200K | 5100K | 5000K | 5000K | 4900K | 4800K | 4700K | 4800K | 100% |
| 9:30 | 5200K | 5300K | 5300K | 5400K | 5400K | 5400K | 5300K | 5300K | 5200K | 5100K | 5000K | 5100K | |
| 10:00 | 5400K | 5500K | 5500K | 5600K | 5600K | 5600K | 5500K | 5500K | 5400K | 5300K | 5300K | 5300K | 100% |
| 10:30 | 5700K | 5800K | 5800K | 5900K | 5900K | 5900K | 5800K | 5800K | 5700K | 5600K | 5600K | 5600K | |
| 11:00 | 6000K | 6000K | 6000K | 6100K | 6100K | 6100K | 6000K | 6000K | 6000K | 5900K | 5900K | 5900K | 100% |
| 11:30 | 6300K | 6300K | 6300K | 6300K | 6300K | 6300K | 6300K | 6300K | 6300K | 6200K | 6200K | 6200K | |
| 12:00 | 6500K | 6500K | 6500K | 6500K | 6500K | 6500K | 6500K | 6500K | 6500K | 6500K | 6500K | 6500K | 100% |
| 12:30 | 6200K | 6200K | 6200K | 6200K | 6200K | 6200K | 6200K | 6200K | 6200K | 6100K | 6100K | 6100K | |
| 13:00 | 5800K | 5900K | 5900K | 6000K | 6000K | 6000K | 5900K | 5900K | 5800K | 5700K | 5700K | 5700K | 100% |
| 13:30 | 5500K | 5600K | 5600K | 5700K | 5700K | 5700K | 5600K | 5600K | 5500K | 5400K | 5400K | 5400K | |
| 14:00 | 5100K | 5200K | 5200K | 5300K | 5400K | 5300K | 5200K | 5200K | 5100K | 5000K | 5000K | 5000K | 100% |
| 14:30 | 4800K | 5000K | 5000K | 5100K | 5100K | 5000K | 4900K | 4900K | 4800K | 4700K | 4600K | 4700K | |
| 15:00 | 4500K | 4700K | 4700K | 4800K | 4900K | 4800K | 4700K | 4600K | 4500K | 4300K | 4200K | 4300K | 100% |
| 15:30 | 4100K | 4300K | 4400K | 4500K | 4600K | 4500K | 4400K | 4300K | 4100K | 3900K | 3800K | 3900K | |
| 16:00 | 3800K | 4000K | 4100K | 4200K | 4300K | 4200K | 4100K | 4000K | 3800K | 3600K | 3500K | 3600K | 100% |
| 16:30 | 3500K | 3700K | 3800K | 3900K | 4100K | 3900K | 3800K | 3700K | 3500K | 3300K | 3100K | 3300K | |
| 17:00 | 3100K | 3300K | 3400K | 3600K | 3800K | 3600K | 3400K | 3300K | 3100K | 2900K | 2700K | 2900K | 100% |
| 17:30 | 2800K | 3000K | 3100K | 3300K | 3500K | 3300K | 3100K | 3000K | 2700K | 2700K | 2700K | 2700K | |
| 18:00 | 2700K | 2700K | 2800K | 3000K | 3200K | 3000K | 2800K | 2700K | 2700K | 2700K | 2700K | 2700K | 100% |
| 18:30 | 2700K | 2700K | 2700K | 2800K | 3000K | 2800K | 2700K | 2700K | 2700K | 2700K | 2700K | 2700K | |
| 19:00 | 2700K | 2700K | 2700K | 2700K | 2700K | 2700K | 2700K | 2700K | 2700K | 2700K | 2700K | 2700K | 100% |
| 19:30 | 2700K | 2700K | 2700K | 2700K | 2700K | 2700K | 2700K | 2700K | 2700K | 2700K | 2700K | 2700K | |
| 20:00 | 2700K | 2700K | 2700K | 2700K | 2700K | 2700K | 2700K | 2700K | 2700K | 2700K | 2700K | 2700K | 100% |
| 20:30 | 2700K | 2700K | 2700K | 2700K | 2700K | 2700K | 2700K | 2700K | 2700K | 2700K | 2700K | 2700K | |
| 21:00 | 2700K | 2700K | 2700K | 2700K | 2700K | 2700K | 2700K | 2700K | 2700K | 2700K | 2700K | 2700K | 90% |
| 21:30 | 2700K | 2700K | 2700K | 2700K | 2700K | 2700K | 2700K | 2700K | 2700K | 2700K | 2700K | 2700K | |
| 22:00 | 2700K | 2700K | 2700K | 2700K | 2700K | 2700K | 2700K | 2700K | 2700K | 2700K | 2700K | 2700K | 80% |
| 23:00 | 2700K | 2700K | 2700K | 2700K | 2700K | 2700K | 2700K | 2700K | 2700K | 2700K | 2700K | 2700K | 70% |

When the communication unit 150 receives time information, the controller 160 may selects a time data value corresponding to the time information and a seasonal section corresponding to the input date value from the time-correlated color temperature correlation information, select a correlated color temperature data value corresponding to the selected time data value and seasonal section, and control the light emitter 120 based on the selected correlated color temperature data value. In other words, the controller 160 can change the correlated color temperature of the light emitter 120 according to increasing time data values after the selected time data value so that the light from the light emitter 120 is similar to natural light.

In addition, the controller 160 may control the light emitter 120 based on input data received by the communication unit 150. The input data may be input by a user operating the control terminal 300. The input data may include a color temperature data value input by the user. In other words, the controller 160 may control the light emitter 120 so that the correlated color temperature of the light of the light emitter 120 is set to the color temperature data value input by the user.

The transmission terminal 200 may communicate with the light emitting device 100 and the control terminal 300 using the first communication method. The transmission terminal 200 may be installed indoors. For example, the transmission terminal 200 may be a Wi-Fi router installed indoors. The transmission terminal 200 may transmit time information to the light emitting device 100. The transmission terminal 200 may include time information that has been input in advance, or may receive time information from an external source such as an NTP server.

The control terminal 300 may communicate with the light emitting device 100 using the second communication method, and may communicate with the control terminal 300 using the first communication method. For example, the control terminal 300 may be a mobile phone, a tablet, a computer, etc. The control terminal 300 may be operated by a user to transmit a driving signal, input data, etc. to the light emitting device 100. In addition, the control terminal 300 may receive status information of the light emitting device 100 using the second communication method and provide it to the user. In other words, the control terminal 300 may display the driving status of the light emitting device 100 and the correlated color temperature of the light of the light emitting device 100 on a screen based on the status information.

By means of the transmission terminal 200 and the control terminal 300, the light emitting device 100 can be driven by a driving signal transmitted from the control terminal 300 in the second communication method to generate light. In addition, the light emitting device 100 can be driven by time information transmitted from the transmission terminal 200 in the second communication method to change the correlated color temperature of light. The light emitting device 100 can change the correlated color temperature of light according to the current time to be similar to natural light. Further, the light emitting device 100 can transmit at least one of the driving signal and the time information to another external light emitting device in the second communication method.

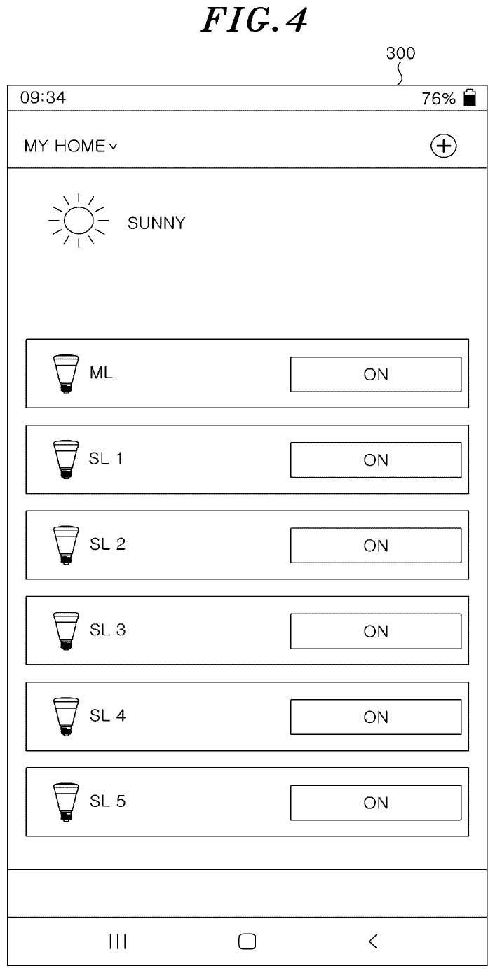

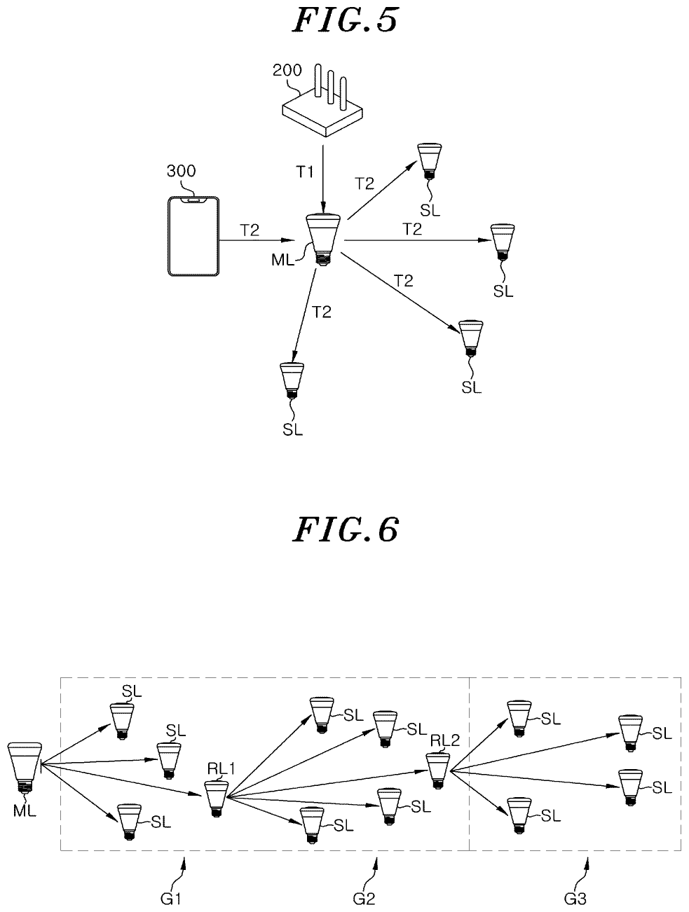

Hereinafter, with reference to FIGS. 4 and 5, a light emitting system 1 according to a second embodiment of the present disclosure will be described. In describing the second embodiment, there is a difference in that the light emitting device 100 may be provided in plurality, and this difference will be mainly described.

The plurality of light emitting devices 100 may communicate with each other using the second communication method. In addition, the plurality of light emitting devices 100 may include a master light emitting device ML and a plurality of slave light emitting devices SL.

The master light emitting device ML is a light emitting device that communicates with the transmission terminal 200 and the control terminal 300 among the plurality of light emitting devices 100. At least one of the plurality of light emitting devices 100 may be set as the master light emitting device ML. For example, the control terminal 300 may set one of the plurality of light emitting devices 100 as the master light emitting device ML, but the present disclosure is not limited thereto. In other words, some of the plurality of light emitting devices 100 may be set as the master light emitting device ML.

The master light emitting device ML may receive time information through the first communication method, and may receive at least one of input data and a driving signal through the second communication method. In addition, the master light emitting device ML may transmit at least one of the time information, the input data, and the driving signal to the plurality of slave light emitting devices SL through the second communication method. Meanwhile, the plurality of master light emitting devices ML may be driven independently of each other.

In other words, the plurality of master light emitting devices ML may not directly communicate with each other, but the present disclosure is not limited thereto.

The plurality of slave light emitting devices SL are light emitting devices that communicate with the master light emitting device ML using the second communication method. For example, the control terminal 300 may set any one of the plurality of light emitting devices 100 as the master light emitting device ML and set all light emitting devices other than the master light emitting device ML as slave light emitting devices SL. The plurality of slave light emitting devices SL may receive one or more of time information, input data, and driving signals via the master light emitting device ML.

In addition, each of the plurality of slave light emitting devices SL may transmit status information to the master light emitting device ML. The master light emitting device ML that receives such status information may transmit the status information of the plurality of slave light emitting devices SL along with its own status information to the control terminal 300.

The control terminal 300 may display status information of the master light emitting device ML and the plurality of slave light emitting devices SL. Based on the status information displayed on the control terminal 300, a user can control the master light emitting device ML and the plurality of slave light emitting devices SL. The user can operate the control terminal 300 to drive at least one of the master light emitting device ML and the plurality of slave light emitting devices SL. In addition, the user can operate the control terminal 300 to change the correlated color temperature of light of at least one of the master light emitting device ML and the plurality of slave light emitting devices SL.

One of the plurality of light emitting devices 100 may be set as the master light emitting device ML and the other light emitting devices may be set as the slave light emitting devices SL. When the master light emitting device ML receives a driving signal through the second communication method, it may be driven by the driving signal to generate light. In addition, the master light emitting device ML may transmit the driving signal to the plurality of slave light emitting devices SL through the second communication method. When the plurality of slave light emitting devices SL receive the driving signal, they may generate light based on the driving signal.

In addition, when the master light emitting device ML receives time information through the first communication method, it may change the correlated color temperature of light based on the time information. In addition, the master light emitting device ML may transmit the time information to the plurality of slave light emitting devices SL through the second communication method. When receiving the time information, the plurality of slave light emitting devices SL may change the correlated color temperature of light based on the time information. Since the correlated color temperatures of the light of the master light emitting device ML and the plurality of slave light emitting devices SL can be changed based on the same time information, they can be adjusted to be identical.

Hereinafter, with reference to FIG. 6, a light emitting device 100 and a light emitting system 1 including the same according to a third embodiment of the present disclosure will be described. In describing the third embodiment, there are differences in that the plurality of light emitting devices 100 may further include one or more sub light emitting devices RL1, RL2, and the plurality of slave light emitting devices SL may be grouped into a plurality of groups, and these differences will be mainly described.

The sub-light emitting devices RL1, RL2 may transmit one or more of the driving signal, time information, and input data transmitted from the master light emitting device ML to some of the plurality of slave light emitting devices SL. The sub-light emitting devices RL1, RL2 may transmit one or more of the driving signal, time information, and input data to a slave light emitting device SL that is not in direct communication with the master light emitting device ML among the plurality of slave light emitting devices SL. At least one of the plurality of slave light emitting devices SL may be set as the sub-light emitting devices RL1, RL2 by the control terminal 300, but the present disclosure is not limited thereto. As an example, the control terminal 300 may set the slave light emitting device SL having the largest distance from the master light emitting device ML among the plurality of slave light emitting devices SL communicating with the master light emitting device ML as the sub-light emitting device RL1, RL2. As another example, a user may operate the control terminal 300 to set at least one of the plurality of slave light emitting devices SL as the sub-light emitting devices RL1, RL2.

In addition, the sub-light emitting devices RL1, RL2 may be provided in plurality. The plurality of sub-light emitting devices RL1, RL2 may include a first sub-light emitting device RL1 and a second sub-light emitting device RL2.

The first sub-light emitting device RL1 may be any one of the plurality of slave light emitting devices SL included in a first group G1 to be described later. For example, among the slave light emitting devices SL included in the first group G1, the slave light emitting device SL having the largest distance from the master light emitting device ML may be set as the first sub-light emitting device RL1. The first sub-light emitting device RL1 may receive at least one of the driving signal, time information, and input data transmitted from the master light emitting device ML through the second communication method, and may transmit at least one of the driving signal, time information, and input data to the plurality of slave light emitting devices SL included in a second group G2 through the second communication method.

The second sub-light emitting device RL2 may be any one of the plurality of slave light emitting devices SL included in the second group G2. For example, the slave light emitting device SL having the largest distance from the first sub-light emitting device RL1 among the slave light emitting devices SL included in the second group G2 may be set as the second sub-light emitting device RL2. The second sub-light emitting device RL2 may communicate with the first sub-light emitting device RL1. The second sub-light emitting device RL2 may receive at least one of the driving signal, time information, and input data transmitted from the first sub-light emitting device RL1 through the second communication method, and may transmit at least one of the driving signal, time information, and input data to the plurality of slave light emitting devices SL included in a third group G3 to be described later through the second communication method.

The plurality of groups may include, but are not limited to, the first group G1, the second group G2, and the third group G3.

The first group G1 may include some of the plurality of slave light emitting devices SL. Among the plurality of slave light emitting devices SL, the slave light emitting devices SL that directly communicate with the master light emitting device ML may be grouped into the first group G1. Any one of the plurality of slave light emitting devices SL included in the first group G1 may be set as the first sub light emitting device RL1.

The second group G2 may include another some of the plurality of slave light emitting devices SL. The slave light emitting devices SL that directly communicate with the first sub light emitting device RL1 among the plurality of slave light emitting devices SL may be grouped into the second group G2. The second group G2 may communicate with the master light emitting device ML via the first sub light emitting device RL1. Any one of the plurality of slave light emitting devices SL included in the second group G2 may be set as the second sub light emitting device RL2.

The third group G3 may include still another some of the plurality of slave light emitting devices SL. Among the plurality of slave light emitting devices SL, the slave light emitting devices SL that directly communicate with the second sub light emitting device RL2 may be grouped into the third group G3. The third group G3 may communicate with the master light emitting device ML via the first sub light emitting device RL1 and the second sub light emitting device RL2.

Among the plurality of light emitting devices 100, the light emitting device 100 that communicates with the control terminal 300 and the transmission terminal 200 may be set as the master light emitting device ML. In addition, among the plurality of light emitting devices 100, the light emitting devices 100 that can communicate with the master light emitting device ML may be set as the slave light emitting devices SL and may be grouped into the first group G1. Then, any one of the plurality of slave light emitting devices SL included in the first group G1 may be set as the first sub light emitting device RL1.

Once the first sub-light emitting device RL1 is set, among the plurality of light emitting devices 100, the light emitting devices 100 that are not included in the first group G1 and can communicate with the first sub-light emitting device RL1 may be set as the slave light emitting devices SL and grouped into the second group G2. Then, any one of the plurality of slave light emitting devices SL included in the second group G2 may be set as the second sub-light emitting device RL2.

Once the second sub-light emitting device RL2 is set, among the plurality of light emitting devices 100, the light emitting devices 100 that are not included in the second group G2 and can communicate with the second sub-light emitting device RL2 may be set as the slave light emitting devices SL and grouped into the third group G3.

By such grouping, even if the plurality of light emitting devices 100 are far apart, at least some of them are connected to each other so that all of the plurality of light emitting devices can receive at least one of the driving signal, time information, and input data. The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A light emitting device comprising:
a light emitter for generating light;
a communication unit that communicates externally through a first communication mode to receive time information and communicates externally through a second communication mode different from the first communication mode; and
a controller for controlling a correlated color temperature of the light of the light emitter based on the time information.

2. The light emitting device of claim 1, wherein the communication unit transmits the time information received using the first communication mode externally through the second communication mode.

3. The light emitting device of claim 2, wherein the communication unit communicates with another light emitting device using the second communication mode and transmits the time information received using the first communication mode to the another light emitting device.

4. The light emitting device of claim 1, wherein the first communication mode is a Wi-Fi mode.

5. The light emitting device of claim 1, wherein the second communication mode is a Bluetooth mode.

6. The light emitting device of claim 1, wherein the light emitter is configured to generate light having a correlated color temperature of 2700K to 6500K.

7. The light emitting device of claim 1, wherein time-correlated color temperature correlation information, which is color temperature data for time data, is input in advance in the controller, and
the controller controls the correlated color temperature of the light generated by the light emitter based on the time-correlated color temperature correlation information.

8. The light emitting device of claim 7, wherein the controller selects time data corresponding to the time information from the time-correlated color temperature correlation information, selects color temperature data corresponding to the selected time data, and controls the light emitter based on the selected color temperature data.

9. The light emitting device of claim 7, wherein the time data includes a plurality of time data values, the color temperature data includes a plurality of correlated color temperature data values, and the time-correlated color temperature correlation information includes a correspondence relationship between the plurality of time data values and the plurality of correlated color temperature data values.

10. A light emitting device comprising:
a light emitter for generating light;
a communication unit that communicates externally through a first communication mode and communicates externally through a second communication mode different from the first communication mode to receive a driving signal; and
a controller that drives the light emitter to emit light when the driving signal is received.

11. The light emitting device of claim 10, wherein the communication unit transmits the driving signal received using the second communication mode externally through the second communication mode.

12. The light emitting device of claim 11, wherein the communication unit communicates with another light emitting device using the second communication mode to transmit the driving signal to the another light emitting device.

13. A light emitting system comprising:
a light emitting device that generates light; and
a transmission terminal that communicates with the light emitting device to transmit time information to the light emitting device,
wherein the light emitting device includes:
a light emitter for generating light;
a communication unit that communicates with the transmission terminal using a first communication mode to receive the time information and communicates externally through a second communication mode different from the first communication mode; and
a controller for controlling a correlated color temperature of the light of the light emitter based on the time information.

14. The light emitting system of claim 13, wherein the light emitting device is provided in plurality, and
the communication units of the plurality of light emitting devices communicate with each other using the second communication mode.

15. The light emitting system of claim 13, wherein the light emitting device is provided in plurality, and
the plurality of light emitting devices include:
one master light emitting device that receives the time information transmitted from the transmission terminal; and
a plurality of slave light emitting devices that receive the time information transmitted from the master light emitting device.

16. The light emitting system of claim 15, wherein the communication unit of the master light emitting device transmits a driving signal received from an external using the second communication mode to the plurality of slave light emitting devices using the second communication mode.

17. The light emitting system of claim 15, wherein the plurality of light emitting devices further include a first sub-light emitting device that receives the time information transmitted from the master light emitting device and transmits the time information to some of the plurality of slave light emitting devices.

18. The light emitting system of claim 17, wherein the plurality of slave light emitting devices are grouped into a plurality of groups, and
wherein the plurality of groups include:
a first group including some of the plurality of slave light emitting devices; and
a second group including another some of the plurality of slave light emitting devices,
wherein the plurality of slave light emitting devices included in the first group receive the time information from the master light emitting device, and
wherein the plurality of slave light emitting devices included in the second group receive the time information from the first sub-light emitting device.

19. The light emitting system of claim 18, wherein among the slave light emitting devices included in the first group, the slave light emitting device with a largest separation distance from the master light emitting device is set as the first sub light emitting device.

20. The light emitting system of claim 18, wherein the plurality of light emitting devices further comprising a second sub-light emitting device that receives the time information transmitted from the first sub-light emitting device,
wherein the plurality of groups further include a third group including still another some of the plurality of slave light emitting devices, and
wherein the plurality of slave light emitting devices included in the third group receive the time information transmitted from the second sub-light emitting device.
